(19) United States
(12) Patent Application Publication
(10) Pub. No.: US 2010/0177119 A1
(43) Pub. Date: Jul. 15, 2010

(54) METHOD AND SYSTEM FOR RENDERING CROSSOVER IMAGES ON HINGED MEDIA

(75) Inventors: Michael E. Farrell, Webster, NY (US); Javier A. Morales, Rochester, NY (US)

Correspondence Address: ORTIZ & LOPEZ, PLLC, P.O. Box 4484, Albuquerque, NM, 87196-4484, US

(73) Assignee: Xerox Corporation

(21) Appl. No.: 12/353,358

(22) Filed: Jan. 14, 2009

(51) Int. Cl. G09G 5/00

(52) U.S. Cl. 345/629

(57) ABSTRACT

A system and method for laying out pages for rendering a crossover image on a hinged media. A position of a hinge within an image and/or a page design element that is to be rendered as a crossover image on the hinged media can be specified. An effective hinge position on a sheet with respect to the hinged media can be determined. Thereafter, two child images can be created by and cropping the crossover image in order to allow sufficient amount of bleed past the hinge position. The child images can be placed on respective pages so that the specified hinge position properly aligns with the effective hinge position of the hinged media.

### TECHNICAL FIELD

Embodiments are generally related to image processing systems and methods. Embodiments are also related to binding systems and techniques. In addition, embodiments relate to methods and systems for rendering crossover images on a hinged media.

### BACKGROUND OF THE INVENTION

Perfect binding can be an ideal solution for books, manuals, magazines and a host of other rendered products due to its attractive combination of versatility and cost-effectiveness. In general, a bookbinding system collects a number of sheets (or pages) into a text body (or book block) that includes a spine and two side hinge areas. The bookbinding system applies an adhesive to the text body spine to bind the sheets together. A cover may be attached to the bound text body by applying an adhesive to the side hinge areas or the spine of the text body, or both. As the number of sheets forming a booklet increases, the fold line of the bound booklet is rounded and bulged, which causes a problem of degradation in appearance and feature of the booklet. A major disadvantage of such typical high volume bindings is that the bound books cannot be opened to lay flat.

Hinged media is one type of specialty media such as, for example, EverFlat™ media, which may constitute a specialty media that can be configured to contain a polyester hinge between the binding spine and the rest of the page. Such a media facilitates the production of books that lay much flatter when opened than conventional books. Crossover pages, also known as spreads, include a single logical design or images such as, for example, maps, diagrams, and panoramic photos that spans two physical pages. Typically, crossovers can be achieved via simple image splitting manually or automatically, which is an adequate solution for saddle stitched and folded publications hence media characteristics are ignored. Currently, it is difficult to properly program such crossover pages to support the hinged media feature because the image must be turned into two cropped images (a recto image and a verso image), which must be positioned properly to avoid white paper showing in the bind area.

The line of image overlap must align with the outer edge of the hinge feature of the hinged media to achieve the effect of the crossover image. Also, when designing books with crossover pages that are to be rendered on the hinged media, it is difficult to position the images correctly on recto and verso pages. Hence, in order to avoid any white paper showing in the bind area, it is desirable to extend the image beyond the hinge into the binding area and such image extension makes it difficult to simply divide the image into halves.

Based on the foregoing, it is believed that a need exists for an improved method and system for laying out pages for rendering the crossover image on the hinged media. A need also exists for positioning the crossover image properly in order to avoid white paper showing in the bind area.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the present invention to provide for an improved image processing method, system and computer-usable medium.

It is another aspect of the present invention to provide for an improved specialty media for rendering crossover images.

It is yet a further aspect of the present invention to provide for an improved method and system for expediting layout of pages comprising a crossover image on a hinged media.

The aforementioned aspects and other objectives and advantages can now be achieved as described herein. A method and system for laying out pages for rendering a crossover image on a hinged media is disclosed. One example of hinged media is the Xerox EverFlat™ media, which is described in greater detail herein. Thus, the crossover image can be rendered on the hinged media via the system and methodology described herein. Note that as utilized herein, the hinged media refers to a specialty media that contains a polyester hinge between a binding spine and the rest of a page. Such a media allows the pages in an open book to lie completely flat rather than bowing or arcing up toward the spine.

A position of a hinge within an image and/or a page design element that is to be rendered as a crossover image on the hinged media can be specified. An effective hinge position on a sheet with respect to the hinged media can be determined. The effective hinge position relates to an edge of the hinge gap furthest from the bind with respect to the hinged media. Thereafter, two child images one for a right page (recto page) and the other for a left page (verso page) can be created by duplicating and cropping the crossover image in order to allow sufficient amount of bleed past the hinge position. The images can be placed on the respective pages so that the specified hinge position properly aligns with the effective hinge position of the hinged media.

The image and/or a page design element can be selected by the user in order to span a gutter or bind to form a finished document. The image can be cropped and scaled to fit a crossover print, typically leaving a portion of the image along the perimeter in order to permit trimming after rendering to achieve a bleed edge rendering effect. The automatic image splitting can be invoked as a function of media properties such as the effective hinge position, which extends the image beyond the effective hinge position. Such an approach requires less operator skill and reduces operator time in laying out pages for rendering the crossover images on the hinged media and the image alignment at the crossover point can be improved.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a schematic view of a computer system in which the present invention may be embodied;

FIG. 2 illustrates a schematic view of a software system including an operating system, application software, and a user interface for carrying out the present invention;

FIG. 3 illustrates a flow chart of operations illustrating logical operational steps of a method for laying out pages for rendering a crossover image on a hinged media, which can be implemented in accordance with a preferred embodiment;

FIG. 4 illustrates an exemplary page layout comprising a crossover image, in accordance with a preferred embodiment;

FIG. 5 illustrates an exemplary page layout comprising the crossover image with a hinge line, in accordance with a preferred embodiment;

FIG. 6 illustrates an exemplary page layout comprising two child images properly positioned with respect to the hinged media, in accordance with a preferred embodiment; and

FIG. 7 illustrates an exemplary book layout comprising crossover images rendered on the hinged media, in accordance with a preferred embodiment.

### DETAILED DESCRIPTION

The particular values and configurations discussed in these non-limiting examples can be varied and are cited merely to illustrate at least one embodiment and are not intended to limit the scope thereof.

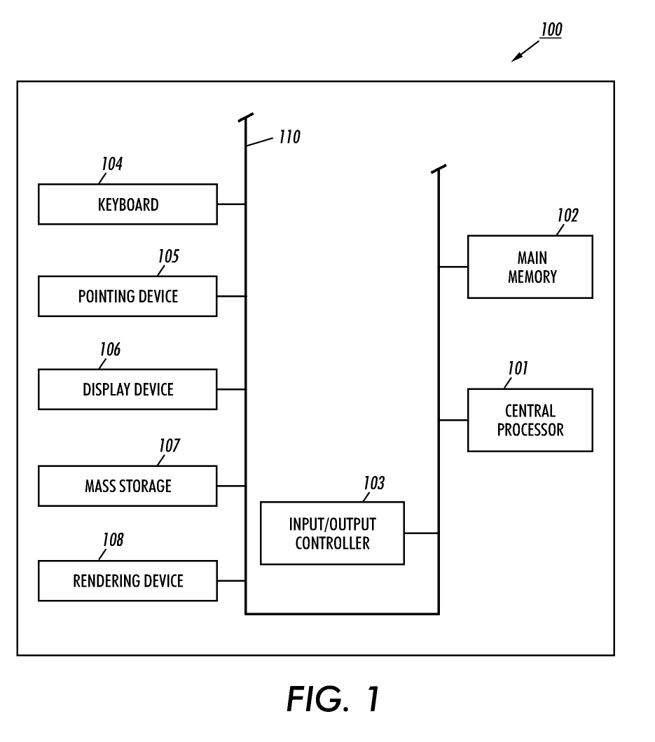

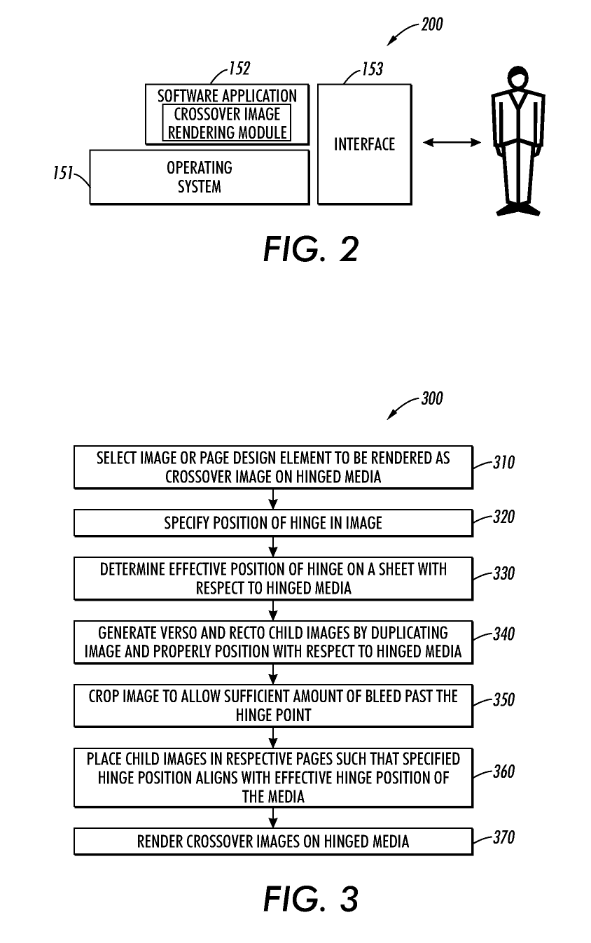

FIGS. 1-2 are provided as exemplary diagrams of data processing environments in which embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

As depicted in FIG. 1, the present invention may be embodied and/or implemented in the context of a data-processing system 100 that generally includes a central processor 101, a main memory 102, an input/output controller 103, an input device such as, for example, a keyboard 104, a pointing device 105 (e.g., mouse, track ball, pen device, or the like), a display device 106, and a mass storage 107 (e.g., hard disk). Additional input/output devices, such as a rendering device 108, may be utilized in association with the data-processing system 100 as desired. As illustrated, the various components of the data-processing system 100 communicate through a system bus 110 or similar architecture.

Illustrated in FIG. 2, a computer software system 200 is provided for directing the operation of the data-processing system 100. Software system 200, which is stored in system memory 102 and on disk memory 107, includes a kernel or operating system 151 and a shell or interface 153. One or more application programs, such as application software 152, may be “loaded” (i.e., transferred from storage 107 into memory 102) for execution by the data-processing system 100. The data-processing system 100 receives user commands and data through user interface 153; these inputs may then be acted upon by the data-processing system 100 in accordance with instructions from operating module 151 and/or application module 152.

The interface 153, which is preferably a graphical user interface (GUI), also serves to display results, whereupon the user may supply additional inputs or terminate the session. In one particular embodiment, operating system 151 and interface 153 can be implemented in the context of a “Windows” system. In another embodiment, operating system 151 and interface 153 may be implemented in the context of other operating systems, such as Linux, UNIX, etc. Application module 152, on the other hand, can include instructions, such as the various operations described herein with respect to the various components and modules described herein such as, for example, the method 300 depicted in FIG. 3.

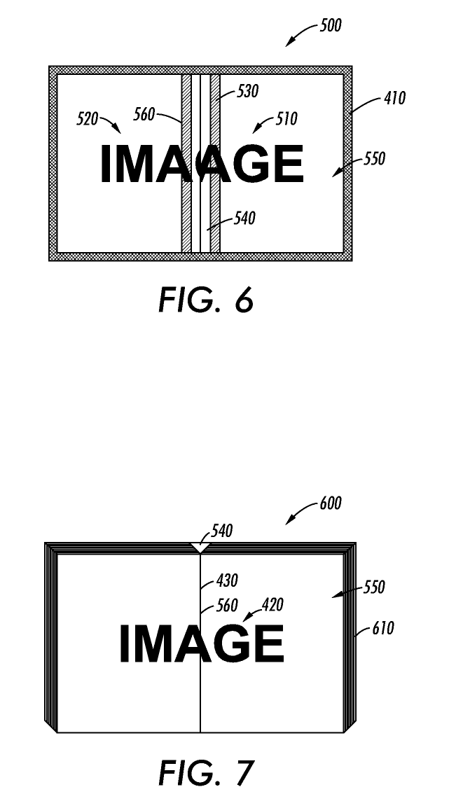

FIG. 3 illustrates a flow chart of operations illustrating logical operational steps of a method 300 for expediting layout of pages comprising a crossover image on a hinged media 550, as shown in FIG. 6, which can be implemented in accordance with a preferred embodiment. Note that the method 300 can be implemented in the context of a computer-useable medium that contains a program product.

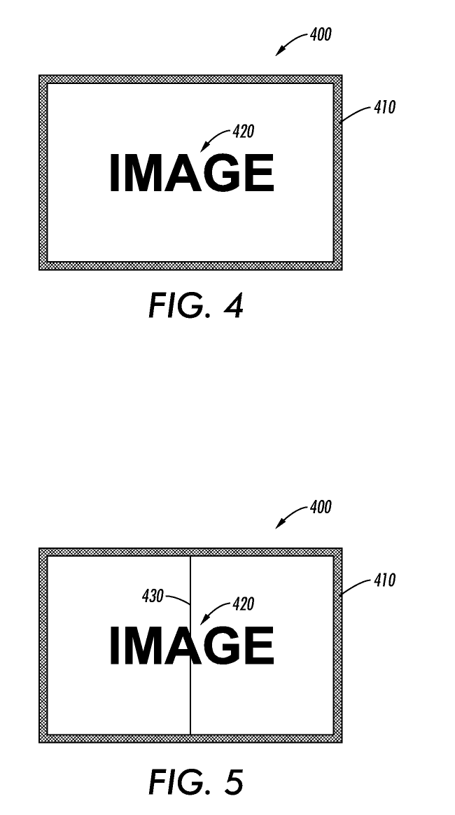

FIG. 4 illustrates an exemplary page layout 400 comprising a crossover image 420, in accordance with a preferred embodiment. An image 420 and/or a design element that is to be rendered as the crossover image on the hinged media 550 can be selected, as shown at block 310. The page layout 400 possesses crossover images such as, for example, maps, diagrams, panoramic photos or tables that span two physical pages. The image 420 can be selected by a user in order to span the gutter or bind to form a finished document. It will be understood by those of ordinary skill in the art, that the term ‘images’ include computer generated graphics, bitmaps, photographs, computer altered photographs, video still frames, scanned images, various forms or artwork, text, background materials, and even video clips, animation, and computer generated time variant materials. The image 420 can be cropped and scaled to fit the crossover print, typically leaving a few millimeters of the image 420 along the perimeter to form a bleed edge 410. The bleed edge 410 can be trimmed after rendering to achieve a bleed edge rendering effect.

FIG. 5 illustrates an exemplary page layout 400 comprising the crossover image 420 with a hinge line 430, in accordance with a preferred embodiment. Note that in FIGS. 1-7, identical or similar blocks are generally indicated by identical reference numerals. The hinge line 430 can be specified by a user in the image 420, as depicted at block 320.

FIG. 6 illustrates an exemplary page layout 500 comprising two child images 510 and 520 properly positioned with respect to the hinged media 550, in accordance with a preferred embodiment. The page layout 500 includes a spine area(s) 540 and two side hinge areas 530 on the hinged media 550. Note that in the depiction illustrated in FIG. 6, the spine area(s) 540 is actually not a single physical component. That is, there are two sheets of paper involved, each with their own spine areas/flaps. One non-limiting example of the hinged media 550 is the Xerox EverFlat™ media, which is described in greater detail herein. It can be appreciated that reference to Xerox EverFlat™ media as utilized herein is discussed for general illustrative and edification purposes only and represents merely one type of hinged media 550 that can be implemented in accordance with one possible embodiment. It should be understood by those skilled in the art, that other types of hinged media may be utilized to implement hinged media 550.

Thus, the crossover image 420 can be rendered on hinged media 550 via the system and methodology described herein. Note that as utilized herein, the hinged media 550 refers generally to a specialty media that contains the hinge area 530 between the binding spine area(s) 540 and the rest of the page 500. The hinge 530 may be configured from a material such as, for example, polyester. Such a media allows the pages in an open book to lie completely flat, rather than bowing or arcing up toward the spine.

A determination can be made whether the image 420 can be rendered onto the hinged media 550. If the image 420 can be rendered utilizing the hinged media 550, an effective position of the hinge area 530 on the page 500 with respect to the hinged media 550 can be determined, as illustrated at block 330. For example, the hinge width may be 3 mm wide with some types of hinged media and the effective hinge position 560 can be the edge of the hinge gap furthest from the bind.

A recto child image 510 and a verso child image 520 can be created by duplicating the image 420 and can be positioned properly with respect to the hinged media 550, as shown at block 340. The hinge line 430 specified in the crossover image 420 can be utilized to automatically crop the image 420 into two child images 510 and 520. The recto image 510 is a duplication of the specified image 420 that can be rendered on the right side of the hinged media 550 and the verso image 520 is a duplication of the specified image 420 that can be rendered on the left side of the hinged media 550. Note that the terms recto and verso describes the right page and left page of a folded sheet or bound item such as a page layout 500, broadsheet or a pamphlet.

The image can be cropped to allow sufficient amount of bleed past the hinge position 560, as depicted at block 350. The child images 510 and 520 can be placed in respective pages such that specified hinge position 430 aligns with effective hinge position 560 of the hinged media 550 as shown at block 360. The crossover images 420 can then be rendered on the hinged media 550, as illustrated at block 370. Note that the data-processing system 100 can be configured to function as rendering (e.g., printing) or binding system that is “aware” of production details associated with a rendering job.

FIG. 7 illustrates an exemplary book layout 600 comprising the crossover image 420 rendered on the hinged media 550, in accordance with a preferred embodiment. Again as reminder, in FIGS. 1-7, identical or similar blocks are generally indicated by identical reference numerals. The book layout 600 includes a number of sheets 610 that includes the spine area(s) 540 and the effective hinge position 560. The two hinge areas 530 as depicted in FIG. 6 folds back allowing the book 600 to be opened and closed. The spine area(s) 540 is the bound edge of the book 600 where the pages are sewn, glued, or otherwise fastened together. Spines are usually thin and flexible, allowing the book to be easily opened. The width of the spine area(s) 540 determines the number of pages to be bound for paper of a given weight. The hinged media 550 comprising the crossover images 420 can be rendered to create the desired content of the book layout 600 consisting of text and images, using the rendering device 108.

The hinged media 550 can be configured as multi-substrate specialty media with the hinge 530 designed to enable crossover pages on perfect bound books (whether soft or hard cover) to lie completely flat when opened. The hinge area 530 of the media 550 is much more flexible than the paper portion of the hinged media 550. When the book pages fold, the first and last pages in the book 600 can fold in the outermost portions of the hinge 530 where the paper portion of the media 550 is under the polyester. The next set of pages can fold at a place in the hinge area 530 closer to the spine area(s) 540 since this set of pages has to “clear” the outermost set of pages. Each subsequent set of pages can fold closer and closer to the spine area(s) 540 until the fold occurs on the inner side of the hinge.

The pages 610 can be bounded together utilizing flexible adhesive. A cover (not shown) can be attached to the layout of the book layout by applying an adhesive to the side hinge areas 530 or the spine area(s) 540, or both. Subsequently, the cropped child images 510 and 520 can be positioned and rendered on two physical pages aligning with respect to the effective hinge position 560. Thus, the specified image 420 allows a sufficient amount of bleed through the hinge position 560 achieving the effect of the crossover image as shown in FIG. 7.

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention. The book 600 can be bound utilizing conventional binding methods such as case binding or perfect binding, the media lies flat allowing the entire page contents to be easily read. The ability of the pages to lay flat in the vicinity of the gutter makes this product more suitable for rendering crossover pages.

Programs defining functions on the present invention can be delivered to a data storage system or a computer system via a variety of signal-bearing media, which include, without limitation, non-writable storage media (e.g., CD-ROM), writable storage media (e.g., hard disk drive, read/write CD ROM, optical media), system memory such as, but not limited to, Random Access Memory (RAM), and communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent. Thus, the method 300 described herein can be deployed as process software in the context of a computer system or data-processing system as that depicted in FIGS. 1-2.

The automatic image splitting can be invoked as a function of the media properties such as the effective hinge position 560, which extends the image beyond the effective hinge position 560. It is believed that by utilizing the system and approach described herein, the concerns of cost and operator skill level associated with page layout for rendering crossovers on the hinged media 550 can be addressed. Such an approach reduces operator time in laying out pages for rendering crossovers on the hinged media 550 and the image alignment at the crossover point can be improved and requires less operator skill.

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A method for laying out pages for rendering crossover images on hinged media, said method comprising:
specifying a hinge position within an image that is to be rendered as a crossover image on a hinged media, wherein said hinged media comprises a hinge between a binding spine and a remainder of a page;
determining an effective hinge position on a sheet with respect to said hinged media in order to thereafter create at least two child images by duplicating and cropping said image in order to allow a sufficient amount of bleed past said effective hinge position; and
positioning said at least two child images on respective pages associated with said hinged media so that said hinge position in said image properly aligns with said effective hinge position of said hinged media, thereby improving said image alignment at a crossover point on said hinged media.

2. The method of claim 1 wherein determining said effective hinge position on said sheet with respect to said hinged media, further comprises determining an outer edge of said hinge associated with said hinged media.

3. The method of claim 1 wherein creating said at least two child images further comprises configuring a recto image with respect to a particular portion of a page.

4. The method of claim 1 further comprising cropping and scaling said image to fit a crossover print by leaving a portion of said image along a perimeter to permit trimming after rendering to achieve a bleed edge rendering effect.

5. The method of claim 1 wherein:
determining said effective hinge position on said sheet with respect to said hinged media, further comprises determining an outer edge of said hinge associated with said hinged media; and
creating said at least two child images further comprises configuring a recto image with respect to a particular portion of a page.

6. The method of claim 5 further comprising cropping and scaling said image to fit a crossover print by leaving a portion of said image along a perimeter to permit trimming after rendering to achieve a bleed edge rendering effect.

7. The method of claim 1 wherein said hinge associated with said hinged media is capable of being configured from a polyester material.

8. The method of claim 1 wherein said hinged media comprises a specialty media.

9. A method for laying out pages for rendering crossover images on hinged media, said method comprising:
specifying a hinge position within an image that is to be rendered as a crossover image on a hinged media, wherein said hinged media comprises a hinge between a binding spine and a remainder of a page;
determining an effective hinge position on a sheet with respect to said hinged media in order to thereafter create at least two child images by duplicating and cropping said image in order to allow a sufficient amount of bleed past said effective hinge position;
positioning said at least two child images on respective pages associated with said hinged media so that said hinge position in said image properly aligns with said effective hinge position of said hinged media, thereby improving said image alignment at a crossover point on said hinged media; and
cropping and scaling said image to fit a crossover print by leaving a portion of said image along a perimeter to permit trimming after rendering to achieve a bleed edge rendering effect.

10. The method of claim 9 wherein determining said effective hinge position on said sheet with respect to said hinged media, further comprises determining an outer edge of said hinge associated with said hinged media.

11. The method of claim 9 wherein creating said at least two child images further comprises configuring a recto image with respect to a particular portion of a page.

12. The method of claim 9 wherein said hinge associated with said hinged media is capable of being configured from a polyester material.

13. The method of claim 9 wherein said hinged media comprises a specialty media.

14. A system for laying out pages for rendering crossover images on hinged media, said system comprising:
a processor;
a data bus coupled to said processor; and
a computer-usable medium embodying computer code, said computer-usable medium being coupled to said data bus, said computer program code comprising instructions executable by said processor and configured for:
specifying a hinge position within an image that is to be rendered as a crossover image on a hinged media, wherein said hinged media comprises a hinge between a binding spine and a remainder of a page;
determining an effective hinge position on a sheet with respect to said hinged media in order to thereafter create at least two child images by duplicating and cropping said image in order to allow a sufficient amount of bleed past said effective hinge position; and
positioning said at least two child images on respective pages associated with said hinged media so that said hinge position in said image properly aligns with said effective hinge position of said hinged media, thereby improving said image alignment at a crossover point on said hinged media.

15. The system of claim 14 wherein determining said effective hinge position on said sheet with respect to said hinged media, further comprises determining an outer edge of said hinge associated with said hinged media.

16. The system of claim 14 wherein creating said at least two child images further comprises configuring a recto image with respect to a particular portion of a page.

17. The system of claim 14 wherein said instructions are further configured for cropping and scaling said image to fit a crossover print by leaving a portion of said image along a perimeter to permit trimming after rendering to achieve a bleed edge rendering effect.

18. The system of claim 14 wherein:
determining said effective hinge position on said sheet with respect to said hinged media, further comprises determining an outer edge of said hinge associated with said hinged media; and
creating said at least two child images further comprises configuring a recto image with respect to a particular portion of a page.

19. The system of claim 14 wherein said hinge associated with said hinged media is capable of being configured from a polyester material.

20. The system of claim 14 wherein said hinged media comprises a specialty media.
